(19) United States
(12) Patent Application Publication
(10) Pub. No.: US 2006/0293910 A1
(43) Pub. Date: Dec. 28, 2006

(54) Method for generating custom postage as part of a fundraising event

(76) Inventor: George A. Castineiras, Farmington, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/396,895

(22) Filed: Apr. 3, 2006

Related U.S. Application Data
(63) Continuation-in-part of application No. 11/168,651, filed on Jun. 27, 2005.

(51) Int. Cl. G06Q 99/00

(52) U.S. Cl. 705/1

(57) ABSTRACT

In a method for offering custom postage as part of a fundraising event, a database is associated with software for manipulating data stored in the database. Inquiries are received regarding offering custom postage as part of a fundraising event. Initial information is collected and stored in the database. A unique organization identification code is generated and associated with the initial information stored in the database. The software extracts relevant information from the database to generate artforms upon which participants in the fundraising event can create artwork. The artforms are distributed and the participants solicit orders for custom postage bearing their artwork. Orders are processed and the custom postage is generated and distributed.

### CROSS REFERENCE TO RELATED APPLICATION

This application is a continuation-in-part of U.S. patent application Ser. No. 11/168,651, filed on Jun. 27, 2005, the disclosure of which is incorporated herein by reference in its entirety.

### FIELD OF THE INVENTION

The present invention relates generally to the conduct of fundraising activities, and is more specifically directed to a fundraiser whereby postage having original artwork thereon is offered for sale, the original artwork being produced by members of the organization benefiting from the fundraiser.

### BACKGROUND OF THE INVENTION

Institutions such as schools, churches, charities, and the like often use fundraising activities to generate the capital needed to offer services or even to continue in existence. These activities typically require a great deal of planning and time to implement. In addition, they are usually “one-time” activities wherein a continuous revenue stream stemming therefrom is not realizable. In addition, these fundraising activities often have limited appeal to large population segments. Moreover, they can be logistically cumbersome as the items sold are sometimes perishable and must be gathered in a common location for distribution or to be picked up. Furthermore, the items offered for sale as part of a fundraiser are sometimes large and consume a great deal of space.

Most fundraisers offer items that are not useable year round on a continuous basis. Accordingly, the need to replenish such items is minimal. In addition, it has been historically difficult for institutions to maintain a sustained year-round fundraising effort. Personnel and other logistical considerations make an ongoing campaign difficult. This is particularly true where the personnel conducting the fundraising activity consist of volunteers who may have competing obligations.

There is a current need to provide a mechanism through which an organization can conduct a sustainable fundraising event having wide appeal. To facilitate such a fundraiser, the item offered for sale must be something most people have an ongoing need for and must be easily handled. The item offered must also be something that will catch the attention of potential purchasers by, for example, being personalized.

Based on the foregoing, it is the general object of the present invention to provide a manner by which institutions and organizations can conduct fundraising activities that improve upon or overcomes the problems and drawbacks of prior art activities.

### SUMMARY OF THE INVENTION

The present invention resides in one aspect in a method for offering custom postage as part of a fundraising event wherein a database is established and is associated with software-based programming for manipulating data stored in the database.

An inquiry from, or on behalf of, an organization regarding offering custom postage as part of a fundraising event begins the process. In response to the inquiry, initial information is collected from the organization and stored in the database. Upon receipt of the initial information the software based programming is used to establish a unique organization identification code and to associate the code with the initial information stored in the database. Information is extracted from the database and used to generate artforms upon which participants in the fundraising event can create their artwork. The organization identification code is associated with the artforms, preferably in the form of a bar code printed directly on the artforms. Once generated, a plurality of the artforms are distributed to the organization and thereby to the participants in the fundraising event.

Next, the participants produce their artwork on the artforms, preferably by drawing directly thereon. However, photographs may also be placed on the artforms. Once their artwork is completed, participants solicit orders for custom postage bearing said participant's artwork thereon. At the conclusion of the fundraising event the artforms and information relevant to the solicited orders as well as information identifying each of the participants is collected and forwarded to the company facilitating the fundraising event. In the preferred embodiment of the present invention, all of this information is embodied in the artforms.

Once the artforms are received, payment information relevant to purchasers of said custom postage is extracted and processed. If any problems occur in processing a payment, the payer is contacted and the situation resolved. Next, an image of each piece of artwork and information relevant to the orders as well as information identifying each of the participants is entered into the database. This information is associated with the relevant organization identification code and a unique participant identification code for each participant is created and associated with the information stored in the database relevant to the participant, as well as with the relevant organization identification code. Printing information for the custom postage is generated and used to cause the custom postage to be printed. Once printed, the custom postage is shipped to the purchasers thereof.

### DETAILED DESCRIPTION OF THE PREFERRED EMBODIMENT

In an embodiment of the present invention, an interested organization, such as, but not limited to a school contacts the entity promoting and providing materials for the fundraiser (hereinafter referred to as “the company”). The company may be contacted by any suitable means, such as, but not limited to, contact via telephone, regular mail, e-mail, or through a website. The contact may occur as a result of advertising by the company, in print, over the web, or on television. However, the present invention is not limited in this regard as contact can be made independent of any advertising or solicitation by or on behalf of the company.

Once the organization decides to engage the company to facilitate a fundraising activity, the company will then gather information from the organization concerning the fundraising event. This information may include, but is not limited to, the organization name, if the organization is a school, the district, complete mailing address, contact phone numbers and e-mail addresses, the name to which the fundraising check should be made out to, the fundraising coordinator's name and phone number, and the best time to contact the coordinator. Other relevant information that may be collected is; will the participants create their artwork as part of a project (in class if participants are students), will artwork be submitted by individuals or by a team or club, how many participants are expected, and what age ranges will be represented.

All of the information gathered is entered into the database which, in connection with software-based programming associated therewith, causes a unique organization identification code to be generated. The organization identification code is then associated with a bar code and art forms having the barcode printed, adhered or otherwise affixed thereon are generated. The art forms preferably comprise an area on one side where the participant can create their artwork. On an opposite side of the artform, an area for entry of orders is provided, as well as, a confirmation area to be filled in by the participant, if not of legal age, by a parent or legal guardian. In addition, an area is provided for providing payment and shipping information, and instructions and terms and conditions are also printed on the artform. While the artform has been described as including several different information bearing areas, the present invention is not limited in this regard as more or fewer areas can be provided on the form without departing from the broader aspects of the present invention. In general, enough artforms are printed to provide each participant with two copies, however more or fewer artforms can also be provided.

Once the artforms have been printed, a starter kit is produced and forwarded to the organization. The starter kit generally includes, the artforms having the above-described bar code printed thereon, a thank you letter, an explanation of what is in the starter kit, a best practice sheet, instructions for returning the completed artforms to the company, and the contact information for an account manager at the company. However, the present invention is not limited in this regard as items may be excluded, or other items included in the starter kit without departing from the broader aspects of the present invention.

Once the starter kit is received, the organization can begin the fundraising event. In general, the fundraising event lasts between two and six weeks. During this period the custom artwork is created on the artforms and orders for custom postage are obtained by the participants. The completed artforms having the initial custom postage orders thereon are then returned to the company. This can be accomplished by the organization collecting the artforms and returning them to the company, or the artforms can be directly mailed or otherwise transmitted to the company by the participants. Upon receiving the artforms, the company processes the payments pursuant to the information provided on the artforms. Payment can be made, or authorized to be made by any number of different methods. For example, payments can be made by credit card, or by using an internet based payment service, such as, for example, PayPal®. In addition, it is contemplated that payment can be made via check, cash or money order. In any instance where the company is unable to process the payment, the company will contact the entity making payment for resolution.

Once payment has been processed, the completed artforms are scanned into the database. Preferably, a high speed scanner is employed to accomplish this task. The scanned information is parsed and appropriately entered into the database. This information includes, but may not be limited to the image on the artform, the barcode information, and initial order information. In addition, some or all of the information may be manually entered. Manual entry may be accomplished twice for each piece of data. When this is done, two different people each enter the same information. If a discrepancy is discovered, the information is checked and the discrepancy is resolved. Checking information obtained from the artforms may also be accomplished electronically. Once the accuracy of the scanned or otherwise input information, including the artwork is verified, a unique identification code is generated for, and associated with the information pertaining to each participant.

The unique participant identification code is matched with the above-described organization identification. This information may be used to create a unique URL and code that a purchaser may access to order or re-order custom postage or other items pertaining to the artwork associated with the particular participant to which the URL pertains.

Once the above-described steps and operations are accomplished, the database will be populated with, inter alia, unique artwork entries, participant/artist information, organization information-the organization information being associated with the relevant participants in the fundraising event, the organization identification code and the unique participant identification code. The database, and software-based programming associated and operable therewith, function to track all art submissions specific to the participant, team or other subset of participants in an organization, such as, but not limited to clubs.

In an embodiment of the present invention, where the organization is a school, the artwork forming part of the completed artforms will only be used for fundraising purposes within a single school year within a two year period from submission. However, the present invention is not limited in this regard as different time periods can be employed without departing from the broader aspects of the present invention. After the 1 year period during which the fundraising event has been conducted, custom postage and other items incorporating participant's artwork may still be purchased. In one embodiment of the present invention a portion of the proceeds for purchases, made after the expiration of the fundraising event, of custom postage or other items incorporating student artwork will be deposited into an account maintained by the company, for the student/participant. This money may be used by the student/participant for school tuition, to start an approved business, or for other company approved activities. In addition, the company may allow the student/participant to designate an approved charity, organization or other entity to which the portion of the proceeds will be designated.

Returning to the conduct of the fund raising event, once the requisite information is received and processed, the custom postage is printed. This can be accomplished using a local printer or the artwork can be forwarded to an approved off-site facility that is authorized by the United States Postal Service to print custom postage. Where an off-site facility is employed, encrypted files are sent to the printing facility for the generation of the custom postage. The encrypted files contain images of the artwork scanned from the artforms, the artist identification code, the organization identification code, and information relevant to the amount of custom postage ordered. In addition, the payment information relevant to the postage printer may also be included in the encrypted data forwarded to the printer. The encrypted data can be forwarded electronically or via the mail on a compact disk or other media. Files may also be sent to ancillary vendors for items incorporating the scanned artwork, such as, but not limited to, mugs, keychains, note cards, and wrapping paper. While has been described, the present invention is not limited in this regard as the data does not have to be encrypted.

Prior to printing the custom postage, a final check may be performed. Any artwork that is inappropriate or for some other reason is deficient such that printing is not advisable, will be returned and a refund for any moneys paid will be processed. Once the final check is performed, any approved artwork will then be printed as custom postage. The custom postage will be in stamp-like form, adhesively backed, and will be provided on sheets with a predetermined number of pieces of custom postage per sheet. Once printed, the custom postage is mailed directly to the purchasers along with a secondary sell sheet to allow participants to accept and place further orders.

Once orders pertaining to a fundraising event have been submitted, programming operable with the database will compile relevant information from the database to generate a financial report. Once generated, the financial report along with appropriate payment is forwarded to the organization. Preferably, a first financial report and payment is made within 60 days of the initial order submission and a second financial report and payment made to the organization at a time corresponding to the end of the fundraising event. For example, where the organization is a school, the second financial report and payment may be made within 60 days of the end of the relevant school year. While two financial reports and payments at particular time periods have been described, the present invention is not limited in this regard as the number of financial reports and payments, as well as the timing associated therewith can vary without departing from the broader aspects of the present invention.

The present invention also contemplates the creation of awards and/or scholarships (hereinafter referred to collectively as scholarships) to be awarded at predetermined intervals, such as but not limited to, annually. The criteria for receiving the scholarships are set by the company and may be administered and evaluated by independent entities. For example, a number of top selling participants in a given area, district, or nationwide, may be chosen as qualifying for a scholarship. A number of independent judges will then evaluate the artwork submitted by each scholarship contender and chose which should receive the scholarships.

In addition to scholarship programs, commemorative awards and/or plaques incorporating the participant's artwork and custom postage may be offered. In addition, and in cooperation with the United States Postal Service, a number of pieces of artwork chosen based on particular criteria such as artistic content can be incorporated into United States postage stamps.

The present invention also contemplates purchasers having the ability to further customize the custom potage they purchase by being able to customize the colors of the printing corresponding to postage amount and any other printing on the postage, as well as borders around the postage. Methods for accomplishing this are disclosed and claimed in U.S. patent application Ser. No. 11/098,807 the disclosure of which is incorporated in their entirety herein by reference. To customize these colors a user accesses a web site where an image of the custom postage can be displayed and associated with a program operable to accomplish the above-referenced color customization. Once the image of the custom postage is displayed, a user selects any color on the image by pointing to it and “clicking” using a mouse or other pointing device. Once selected, that color is reproduced in the postage areas of the custom postage. In addition, the program can also generate a palette of selectable colors that are complimentary to the color selected with appropriate and necessary level of contrast. Once the palette is generated one or more of the colors thereon can be selected to customize the textual portion of the postage area.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A method for offering custom postage as part of a fundraising event, said method comprising the steps of:
establishing a database for storing data therein, said database being associated with software-based programming for manipulating said data;
receiving an inquiry from, or on behalf of, an organization regarding offering custom postage as part of a fundraising event;
collecting initial information from said organization and storing said initial information in said database;
causing said software based programming to generate a unique organization identification code and to associate said unique organization identification code with said initial information stored in said database;
causing said software-based programming to extract relevant information from said database and to generate artforms upon which participants in said fundraising event can create artwork, said artforms having said unique organization identification code associated therewith;
distributing a plurality of said artforms to said organization and thereby to said participants;
said participants causing said artwork to be produced on said artform;
said participants soliciting orders for custom postage bearing said participant's artwork thereon;
collecting said artforms, information relevant to said orders and information identifying each of said participants;
extracting payment information relevant to purchasers of said custom postage and processing payments therefore;
entering an image of each piece of artwork, said information relevant to said orders and said information identifying each of said participants into said database;
said software-based programming causing said images of said artwork said information relevant to said orders and said information identifying each of said participants to be associated with one another and with the relevant organization identification code;
causing said software based programming to generate a unique participant identification code for each participant and to associate said participant identification code with, the information stored in said database relevant to said participant, and with the relevant organization identification code;
causing said software-based programming to manipulate said data stored in said database to generate printing information for said custom postage;
using said printing information to print said custom postage; and
shipping said printed custom postage to said purchasers thereof.

2. A method as defined by claim 1 wherein said step of shipping said printed custom postage further includes shipping secondary sell sheets with said printed custom postage; said method including the further step of:
accepting additional orders for said custom postage subsequent to receiving an initial order of said custom postage.

3. A method as defined by claim 1 wherein prior to said step of receiving an inquiry, said method includes the further step of:
establishing a web site having information pertaining to offering custom postage as part of a fundraising event, said website further including means for contacting a company facilitating said fundraising event; and
said step of receiving an inquiry further includes accessing said web site to electronically contact said company.

4. A method as defined by claim 1 wherein said artform comprises:
a first side having an area whereon a participant can create artwork; and
an opposing second side including one area for notating orders for custom postage, another area wherein a parent or legal guardian can affirm by signature their assent to a participant's participation in said fundraising event, and
another area wherein terms and conditions are set forth.

5. A method as defined by claim 1 wherein said step of delivering a plurality of said artforms includes delivering said artforms as part of a starter kit, said starter kit including a best practice sheet, instructions for completing said artforms, and contact information for said company.

6. A method as defined by claim 5 wherein said starter kit further includes an informational CD or DVD.

7. A method as defined by claim 1 wherein said step of generating said artforms having said unique organization identification code associated therewith, further includes causing a bar code indicative of said unique organization identification code to be printed onto each of said artforms, said step of entering an image includes scanning said image and said bar code into said database; and said step of said software-based programming causing said images of said artwork said information relevant to said orders and said information identifying each of said participants to be associated with one another and with the relevant organization identification code further includes associating said barcode with said organization code.

8. A method as defined by claim 1 wherein said step of processing said payments includes, accepting payments by one or more of cash, check, and credit card.

9. A method as defined by claim 3 wherein said step of processing said payments further includes accessing said web site and activating a link to an internet based payment system and completing an electronic funds transfer thereby.

10. A method as defined by claim 1 comprising the further steps of causing said software based programming to extract said participant identification codes and said organization identification codes associated therewith from said database and to generate URL's, each URL being unique to a particular participant, from which custom postage bearing images unique to said particular participant can be ordered.

11. A method as defined by claim 1 wherein said step of causing said software-based programming to manipulate said data stored in said database to generate printing information for said custom postage, further includes encrypting said printing information and electronically transferring said encrypted printing information to a custom postage printing facility.

12. A method as defined by claim 1 wherein said step of entering an image of each piece of artwork, said information relevant to said orders and said information identifying each of said participants into said database; includes scanning said artwork into said database and manually inputting at least a portion of said information relevant to said orders and said information identifying each of said participants into said database; and wherein
said step of manually inputting includes verifying said manually input information by causing two different individuals to each enter said manually input information and if a discrepancy is found, resolving said discrepancy before said manually input information is transferred to said database.

13. A method as defined by claim 1 comprising the further steps of:
conducting said fundraising event for a predetermined period of time;
generating at least one financial statement identifying the portion of the proceeds from the fundraising event to which said organization is entitled; and
forwarding payment of said portion of said proceeds to said organization.

14. A method as defined by claim 3 further comprising;
said purchaser accessing said website;
said purchaser entering said participant identification code to access images of custom postage unique to said participant;
said purchaser selecting a particular color, using a pointing device, on said image forming a portion of said custom postage;
software associated with said website, causing portions of said custom postage other than said image to become said particular color; and
said purchaser ordering via said website said custom postage wherein said portions of said custom postage other than said image to become said particular color.

15. A method as defined by claim 14 wherein said software further causes a palette of colors to appear on a display at which said purchaser is viewing said custom postage, said palette of colors being complementary to said particular color selected by said purchaser, and wherein
said purchaser may selectively choose one of said colors from said palette of colors thereby causing said portions of said custom postage other than said image to become said color selected from said palette of colors.

16. A method as defined by claim 1 further comprising the steps of:
causing said software-based programming, in cooperation with said database, to generate statistical information relevant to predetermined criteria;
using said statistical information to determine participants eligible for a scholarship or prize offered by said company;
independently evaluating at least one of said artwork and said sales attributable to said eligible participants;
selecting at least one of said eligible participants as a recipient of said scholarship or prize and awarding said scholarship or prize to said eligible participant.

17. A method as defined by claim 13 comprising the further steps of:
subsequent to an expiration of said predetermined period of time purchases of custom postage relevant to individual participants are tracked by said database in cooperation said software-based programming associated therewith;
establishing an account for said individual participant;
depositing a portion of the proceeds of said purchases of custom postage relevant to said individual participant into said account; and
allowing said portion of said proceeds to be used for purposes approved by said company.
